(19) United States
(12) Patent Application Publication
(10) Pub. No.: US 2022/0197696 A1
(43) Pub. Date: Jun. 23, 2022

(54) CONDENSED COMMAND PACKET FOR HIGH THROUGHPUT AND LOW OVERHEAD KERNEL LAUNCH

(71) Applicant: Advanced Micro Devices, Inc., Santa Clara, CA (US)

(72) Inventors: Sooraj Puthoor, Austin, TX (US); Bradford M. Beckmann, Bellevue, WA (US)

(73) Assignee: Advanced Micro Devices, Inc., Santa Clara, CA (US)

(21) Appl. No.: 17/133,574

(22) Filed: Dec. 23, 2020

(51) Int. Cl. G06F 9/48

(52) U.S. Cl. CPC G06F 9/4881; G06F 9/485

(57) ABSTRACT

Methods, devices, and systems for launching a compute kernel. A reference kernel dispatch packet is received by a kernel agent. The reference kernel dispatch packet is processed by the kernel agent to determine kernel dispatch information. The kernel dispatch information is stored by the kernel agent. A kernel is dispatched by the kernel agent, based on the kernel dispatch information. In some implementations, a condensed kernel dispatch packet is received by the kernel agent, the condensed kernel dispatch packet is processed by the kernel agent to retrieve the stored kernel dispatch information, and a kernel is dispatched by the kernel agent based on the retrieved kernel dispatch information.

### BACKGROUND

Many high-performance computing (HPC) applications (e.g., Kripke) include a sequence of kernels that is launched multiple times in a loop (e.g., a “task graph”). With improvements in GPU execution time, the time needed to launch each kernel becomes an appreciable factor in the overall performance of the application. Put another way, as the ratio of kernel launch overhead to kernel execution time increases, the launch overhead becomes an increasing part of the critical path for application performance.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail;

FIG. 3 is a flow chart illustrating an example process for kernel packet launch and execution;

FIG. 4 is a task graph illustrating example kernels for execution in an example application;

FIG. 5 is a block diagram illustrating example processing time and overhead time components associated with processing each of the kernels described with respect to FIG. 4;

FIG. 6 is a flow chart illustrating an example process for kernel packet launch and execution using an example condensed kernel dispatch packet; and

FIG. 7 is a block diagram illustrating example processing time and overhead time components associated with processing each of the kernels described with respect to FIG. 4, according to the process shown and described with respect to FIG. 6.

### DETAILED DESCRIPTION

Some implementations provide a kernel agent configured to dispatch a compute kernel for execution. The kernel agent includes circuitry configured to receive a reference kernel dispatch packet. The kernel agent also includes circuitry configured to process the reference kernel dispatch packet to determine kernel dispatch information. The kernel agent also includes circuitry configured to store the kernel dispatch information. The kernel agent also includes circuitry configured to dispatch a kernel based on the kernel dispatch information.

In some implementations, the kernel agent includes circuitry configured to receive a condensed kernel dispatch packet, circuitry configured to process the condensed kernel dispatch packet to retrieve the stored kernel dispatch information, and circuitry configured to dispatch a kernel, based on the retrieved kernel dispatch information. In some implementations, the kernel agent includes circuitry configured to receive a condensed kernel dispatch packet, circuitry configured to process the condensed kernel dispatch packet to retrieve the kernel dispatch information and to determine difference information, circuitry configured to modify the retrieved kernel dispatch information based on the difference information, and circuitry configured to dispatch a kernel, based on the modified retrieved kernel dispatch information.

In some implementations, the kernel agent includes circuitry configured to receive a condensed kernel dispatch packet, circuitry configured to process the condensed kernel dispatch packet to retrieve the stored kernel dispatch information and to retrieve stored second kernel dispatch information, and circuitry configured to dispatch a kernel based on the retrieved kernel dispatch information, and to dispatch a second kernel based on the retrieved second kernel information. In some implementations, the kernel agent includes circuitry configured to receive a condensed kernel dispatch packet, circuitry configured to process the condensed kernel dispatch packet to retrieve the stored kernel dispatch information, to determine first difference information, to retrieve stored second kernel dispatch information, and to determine second difference information, circuitry configured to modify the retrieved kernel dispatch information based on the first difference information, circuitry configured to modify the retrieved second kernel dispatch information based on the second difference information, and circuitry configured to dispatch a first kernel based on the modified kernel dispatch information, and to dispatch a second kernel based on the modified second kernel dispatch information.

In some implementations, the kernel agent includes a reference state buffer, and the kernel dispatch information is stored in the reference state buffer. In some implementations, the kernel agent includes a scratch random access memory (RAM), and the kernel agent stores the kernel dispatch information in the scratch RAM. In some implementations, the kernel agent is or includes a graphics processing unit (GPU). In some implementations, the kernel agent includes circuitry configured to receive the reference kernel dispatch packet from a host processor. In some implementations, the reference kernel dispatch packet comprises architected queuing language (AQL) fields.

Some implementations provide a method for dispatching a compute kernel for execution. A reference kernel dispatch packet is received by a kernel agent. The reference kernel dispatch packet is processed by the kernel agent to determine kernel dispatch information. The kernel dispatch information is stored by the kernel agent. A kernel is dispatched by the kernel agent, based on the kernel dispatch information.

In some implementations, a condensed kernel dispatch packet is received by the kernel agent, the condensed kernel dispatch packet is processed by the kernel agent to retrieve the stored kernel dispatch information, and a kernel is dispatched by the kernel agent based on the retrieved kernel dispatch information. In some implementations, a condensed kernel dispatch packet is received by the kernel agent, the condensed kernel dispatch packet is processed by the kernel agent to retrieve the kernel dispatch information and to determine difference information, the retrieved kernel dispatch information is modified by the kernel agent based on the difference information; and a kernel is dispatched by the kernel agent, based on the modified retrieved kernel dispatch information.

In some implementations, a condensed kernel dispatch packet is received by the kernel agent, the condensed kernel dispatch packet is processed by the kernel agent to retrieve the stored kernel dispatch information and to retrieve stored second kernel dispatch information, a kernel is dispatched by the kernel agent based on the retrieved kernel dispatch information, and a second kernel is dispatched by the kernel agent based on the retrieved second kernel dispatch information.

In some implementations, a condensed kernel dispatch packet is received by the kernel agent, the condensed kernel dispatch packet is processed by the kernel agent to retrieve the stored kernel dispatch information, to determine first difference information, to retrieve stored second kernel dispatch information, and to determine second difference information, the retrieved kernel dispatch information is modified based on the first difference information, the retrieved second kernel dispatch information is modified based on the second difference information, a first kernel is dispatched based on the modified kernel dispatch information, and a second kernel is dispatched based on the modified second kernel dispatch information.

In some implementations, the kernel agent stores the kernel dispatch information in a reference state buffer. In some implementations, the kernel agent stores the kernel dispatch information in a scratch random access memory (RAM) on the kernel agent. In some implementations, the kernel agent is or includes a graphics processing unit (GPU). In some implementations, the reference kernel dispatch packet is received from a host processor. In some implementations, the reference kernel dispatch packet comprises architected queuing language (AQL) fields.

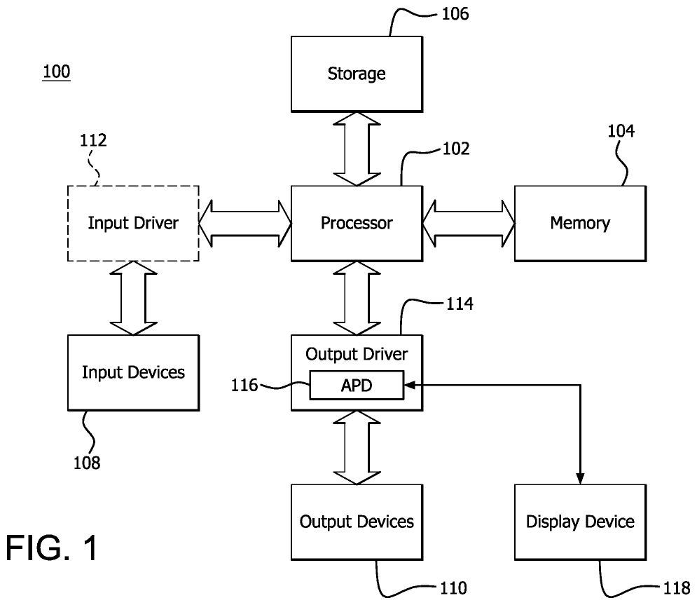

FIG. 1 is a block diagram of an example device 100 in which one or more features of the disclosure can be implemented. The device 100 can include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 116 includes an accelerated processing device (“APD”) 116 which is coupled to a display device 118. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm performs the functionality described herein.

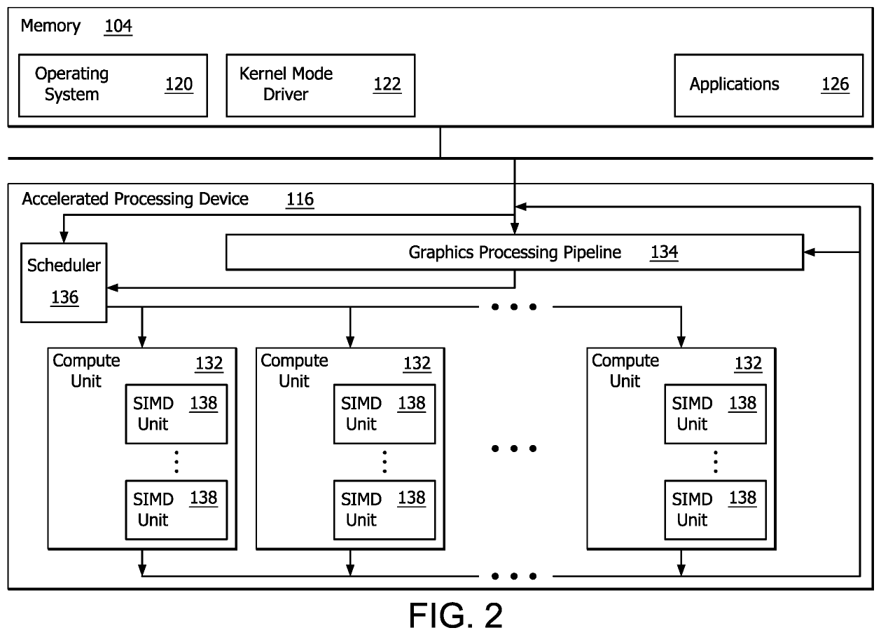

FIG. 2 is a block diagram of the device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that perform operations at the request of the processor 102 in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 performs operations related to scheduling various wavefronts on different compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

In some HPC and other applications, a host processor (e.g., CPU) launches one or more processor kernels for execution on a GPU or other processor. The GPU or other processor executing the kernel (e.g., a GPU kernel, in the case of a GPU) is referred to as a kernel agent in some contexts.

Typically, the host processor launches a kernel for execution on a kernel agent by enqueuing a specific type of command packet for processing by the kernel agent. This type of command packet can be referred to as a kernel dispatch packet. For example, the heterogeneous system architecture (HSA) standard specifies an architected queuing language (AQL) kernel dispatch packet (referred to as hsa_kernel_dispatch_packet) for this purpose. Table 1 illustrates an example hsa_kernel_dispatch_packet.

```
TABLE 1
hsa_kernel_dispatch_packet {
  unit8_t header = HSA_PACKET_TYPE_KERNEL_DISPATCH;
  unit8_t synch_scopes;
  unit16_t setup;
  unit16_t workgroup_size_x;
  unit16_t workgroup_size_y;
  unit16_t workgroup_size_z;
  unit16_t reserved0;
  unit32_t grid_size_x;
  unit32_t grid_size_y;
  unit32_t grid_size_z;
  unit16_t private_segment_size;
  unit32_t group_segment_size;
  unit64_t kernel_object;
  void* kernarg_address;
  unit64_t reserved2;
  hsa_signal_t completion_signal;
};
```

The format and fields of this example kernel dispatch packet are exemplary. It is noted that other implementations use other formats and/or fields, and/or are not specific to AQL. In some cases, the host enqueues the kernel dispatch packet in a specific queue designated for the kernel agent. A packet processor of the kernel agent processes the kernel dispatch packet to determine kernel execution information (e.g., dispatch and “cleanup” information).

In some implementations, the dispatch information includes information for dispatching the kernel for execution on the kernel agent (a GPU in this example). In the example hsa_kernel_dispatch_packet of Table 1, synchronization scopes (synch_scopes), setup, workgroup size, grid size, private segment size, group segment size, kernel object and kernarg address are part of the dispatch information. These fields provide information about the scope of an acquire operation to be performed before launching work on the GPU (synch_scopes field), a GPU kernel dimension that indicates how GPU threads are organized in that kernel (setup field), a number of threads in the GPU kernel (workgroup and grid size fields), an amount of scratch and on-chip local memory consumed by the GPU threads of this kernel (private and group segment size respectively), the GPU kernel code itself (code object) and the arguments to the GPU kernel (kernarg_address). These fields are examples, and in some implementations the kernel dispatch packets include different dispatch information (e.g., different fields, or a greater or lesser number of fields), e.g., depending on the kernel agent implementation.

In some implementations, the cleanup information includes information for performing actions after the kernel execution on the kernel agent is complete. In the example hsa_kernel_dispatch_packet of Table 1, synch_scopes and completion signal are part of the cleanup information. The synch_scopes field provides information about the scope of a release operation to be performed after work is completed on the GPU. The completion signal is used to notify the host (e.g., CPU) and/or other agents waiting on this completion signal about the completion of the work.

It is noted that the synch_scopes field provides both dispatch and cleanup information in this example. For example, the scope of an acquire memory fence before execution of the kernel is dispatch information, and the scope of a release memory fence after execution of the kernel is cleanup information. In some implementations the dispatch and cleanup information is provided in separate fields.

In some implementations, the dispatch and cleanup information are derived from the fields of the kernel dispatch packet, and the structure of the dispatch and cleanup information derived from the fields is implementation specific.

The kernel agent dispatches the kernel for execution based on the kernel dispatch information, and performs cleanup based on the cleanup information after the kernel execution completes. These steps are exemplary, and may include sub-steps, different steps, more steps, or fewer steps, in other implementations.

Typically, a kernel dispatch packet is enqueued and processed, and the kernel is dispatched for execution and cleaned up for each kernel that is run in an application. In this example kernel processing approach, the enqueuing, packet processing, and cleanup operations are typically performed by a command processor or other suitable packet processing hardware of the kernel agent, whereas the kernel execution is typically performed by a compute unit (e.g., a SIMD device) or other primary processing unit of the kernel agent. Regardless of what hardware carries out each operation, the time spent carrying out the enqueuing, packet processing, and cleanup operations is considered overhead to the kernel execution.

Thus, for an application which executes several processor kernels, the application run time will include the kernel execution time and the kernel overhead time for each of the processor kernels. Further, many applications include a sequence of kernels (e.g., short running kernels) that are executed multiple times in a loop. As kernel execution times improve (i.e., become shorter), the overhead associated with launching the kernels for execution becomes a larger proportion of the overall kernel processing time, and becomes increasingly important to the overall performance of the application.

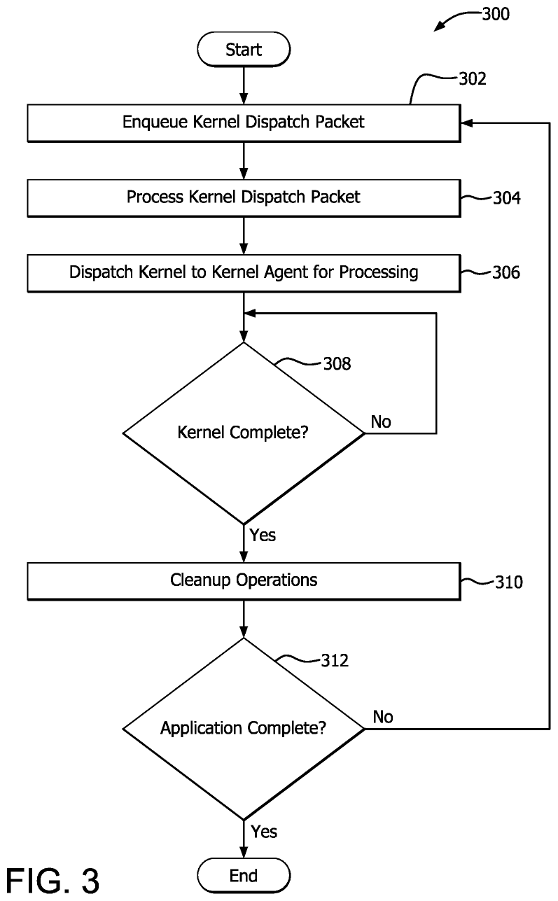

FIG. 3 is a flow chart illustrating an example process 300 for kernel packet launch and execution.

In step 302 a kernel dispatch packet is enqueued for processing by a kernel agent. The kernel dispatch packet is a hsa_kernel_dispatch_packet, a modified version (e.g., as described herein) of such packet, or any other suitable packet or information for supporting kernel launch and execution. In some implementations, the kernel dispatch packet is enqueued in a queue which corresponds to the kernel agent. In some implementations, the kernel dispatch packet is enqueued by a host processor, such as a CPU, for processing by the kernel agent. In some implementations, the kernel agent is or includes a GPU, DSP, CPU, or any other suitable processing device.

In step 304, the kernel agent processes the kernel dispatch packet. In some implementations, a packet processor or other packet processing circuitry of the kernel dispatch agent processes the kernel dispatch packet. In other implementations, general processing circuitry of the kernel agent processes the packet. In some implementations, kernel dispatch packet is processed to determine information for executing the kernel on the kernel agent. In some implementations, the information includes dispatch information, and cleanup information.

In step 306, the kernel agent dispatches the kernel for execution on the kernel agent (e.g., GPU) based on the information processed from the kernel dispatch packet, and the kernel executes until completion. On condition 308 that the kernel execution completes, cleanup operations are performed in step 310. In some implementations, the cleanup operations are performed by the kernel agent based on the information processed from the kernel dispatch packet. On condition 312 that the application is not complete, process 300 repeats from step 302 with enqueuing of a kernel dispatch packet for the next kernel. Otherwise, process 300 ends.

As can be seen from the example of FIG. 3, overhead due to enqueuing and processing of the kernel dispatch packet, and due to cleanup operations, accrues each time a kernel is launched on the kernel agent.

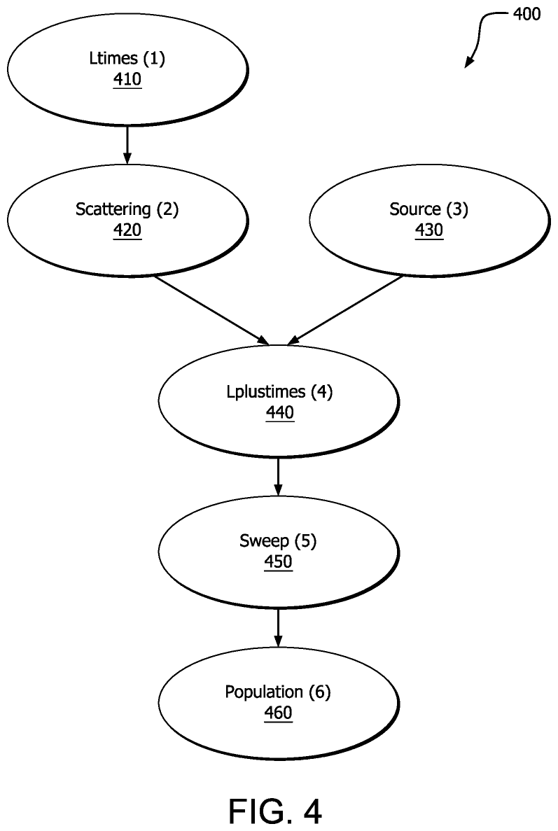

FIG. 4 is a task graph 400 illustrating example kernels for execution in an example application. Task graph 400 illustrates typical kernels for the Kripke application as an example, however the concept is general to any application and set of kernels. Task graph 400 includes Ltimes kernel 410, Scattering kernel 420, Source kernel 430, Lplustimes kernel 440, Sweep kernel 450, and Population kernel 460. It is noted that specific kernels described are exemplary only, and their specific names and functions are immaterial to the example. To execute the application, each kernel is launched and executed in the order shown. In some implementations, after all of the kernels have been launched and executed, the kernels are launched and executed again. For example, in Kripke, the kernels are launched and executed again in the order shown in the task graph in some cases, depending on a convergence analysis of data produced by the previous iteration of the task graph.

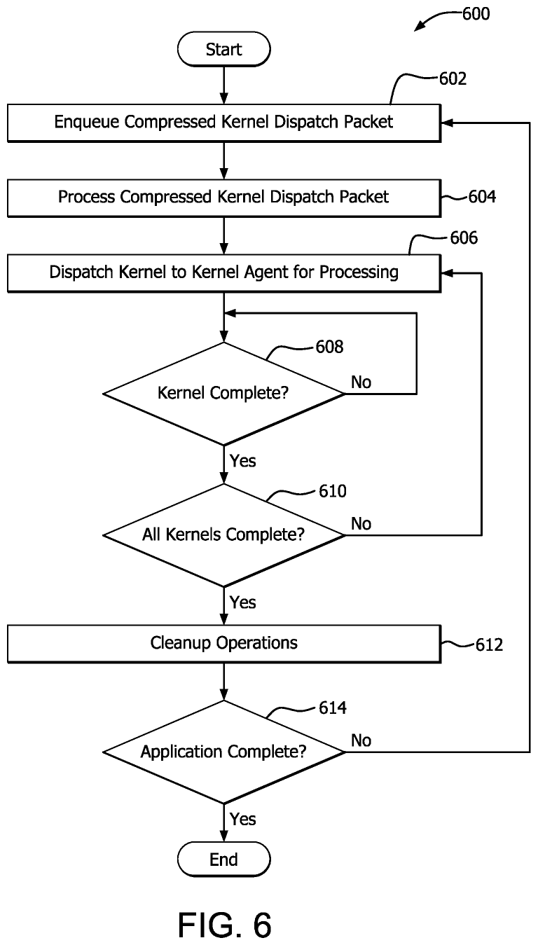

FIG. 6 is a block diagram illustrating example processing time and overhead time components associated with processing each of the kernels 410, 420, 430, 440, 450, 460 shown and described with respect to FIG. 4, according to process 300 shown and described with respect to FIG. 3. As shown, each kernel includes overhead time due to enqueuing the kernel dispatch packet and processing the kernel dispatch packet, processing time for dispatching and executing the kernel on the kernel agent, and overhead time for cleanup operations. The blocks shown illustrate operations contributing to overhead time, processing time, dispatch time, execution time, and cleanup time for kernels 410, 420, 430, 440, 450, 460, and are not intended to be to scale, or to imply that the kernels necessarily run in parallel, although some or all kernels may in fact run in parallel or may overlap in some implementations.

In order to reduce overhead time, such as kernel enqueuing, packet processing, and/or cleanup overhead, during execution of an application, some implementations include a packet configured for storing information relevant to a kernel, such as dispatch, execution, and/or cleanup information. Such packets are referred to herein as reference kernel dispatch packets.

In some implementations, the reference packet includes information indicating that reference packet information, or information processed from the reference packet, is to be stored in a memory for future access. In some implementations, the reference packet includes an index to a location where the information is to be stored. In some implementations, the reference packet is a modified version of the kernel dispatch packet. For example, Table 2 illustrates an example modified hsa_kernel_dispatch_packet, where the unit16_t reserved0 field is repurposed to include a reference number (uint16_t ref_num).

```
TABLE 2
hsa_kernel_dispatch_packet {
  unit8_t header = HSA_PACKET_TYPE_KERNEL_DISPATCH;
  unit8_t synch_scopes;
  unit16_t setup;
  unit16_t workgroup_size_x;
  unit16_t workgroup_size_y;
  unit16_t workgroup_size_z;
  unit16_t ref_num; // Reference number
  unit32_t grid_size_x;
  unit32_t grid_size_y;
  unit32_t grid_size_z;
  unit16_t private_segment_size;
  unit32_t group_segment_size;
  unit64_t kernel_object;
  void* kernarg_address;
  unit64_t reserved2;
  hsa_signal_t completion_signal;
};
```

The format and fields of this example reference dispatch packet are exemplary. It is noted that other implementations use other formats and/or fields, and/or are not specific to AQL. In some implementations, the information is stored in a buffer, which can be referred to as a reference state buffer (RSB). The RSB is any suitable buffer, such as a scratch ram on the kernel agent, a region of GPU memory of the kernel agent, or any other suitable memory location. In some implementations, the information is stored in a reference state table (RST) of the RSB, e.g., indexed by a reference number from the reference packet (e.g., ref_num in the example packet of Table 2.) Table 3 illustrates an example RST, which includes 8 entries for storing information from reference packets.

TABLE 3

| | |
|---|---|
| 8 | |
| 7 | |
| 6 | {CLEANUP_INFO, DISP_INFO}₆ |
| 5 | |
| 4 | {CLEANUP_INFO, DISP_INFO}₄ |
| 3 | {CLEANUP_INFO, DISP_INFO}₅ |
| 2 | |
| 1 | |
| Index | Pre-processed information |

In some implementations, using reference packets, (e.g., the modified hsa_kernel_dispatch_packet of Table 2), rather than ordinary kernel dispatch packets, (e.g., the hsa_kernel_dispatch_packet of Table 1) to launch kernels 410, 420, 430, 440, 450, 460 shown and described with respect to FIG. 4 using process 300, shown and described with respect to FIG. 3, causes the information processed from each reference kernel dispatch packet to be stored in a RST of a RFB (e.g., the example RST of Table 3).

In order to leverage the information stored in the RFB to reduce kernel overhead (e.g., enqueuing, launch packet processing, and/or cleanup time) during execution of an application, some implementations include a packet configured for dispatching multiple kernels. Such packets are referred to herein as condensed kernel dispatch packets.

In some implementations, the condensed kernel dispatch packet includes information indicating a number of kernels for dispatch, an index to reference information (e.g., stored in the RFB) for each kernel, and/or difference information (e.g., a difference vector) for each kernel.

In some implementations, the number of kernels for dispatch indicates a number of kernels to be launched based on the information referenced by the condensed kernel dispatch packet. In some implementations, the difference information indicates one or more ways in which the information referenced by the condensed kernel dispatch packet (e.g., information stored in the RFB) should be modified for dispatching the kernel according to the condensed kernel dispatch packet (referred to as difference information or “diff” herein), or that the information referenced by the condensed kernel dispatch packet should not be modified for dispatching the kernel according to the condensed kernel dispatch packet.

For example, Table 4 illustrates an example condensed kernel dispatch packet format:

TABLE 4

```
hsa_condensed_dispatch_packet {
  unit8_t header =
  HSA_PACKET_TYPE_CONDENSED_DISPATCH;
  unit8_t num_kernels;
  unit16_t diff_values[31]; //62 bytes of Diff information;
};
```

The header field specifies that the packet is a condensed dispatch packet, and that the packet carries the diff from the reference packet for each dispatch. The num_kernels field specifies the number of kernels this single condensed dispatch packet dispatches. The diff_values specify each kernel's diff compared to their respective reference packet. The format and fields of this example condensed dispatch packet are exemplary. It is noted that other implementations use other formats and/or fields, and/or are not specific to AQL.

For example, Table 5 illustrates an example header for expressing a difference (e.g., “diff” information) from the information stored in the RFB:

TABLE 5

| | |
|---|---|
| struct diff_params { | |
| unsigned ref_num : 3; | // reference number |
| unsigned diff_vector : 13; | //diff vector |
| }; | |

The diff header is a preamble indicating the diff of a kernel from its reference packet. The diff header is a preamble to the cliff, that indicates which reference table entry is used as a baseline for the diff (i.e., ref_num in this example) and which fields are different (i.e., diff_vector in this example). After the preamble, the diff itself is sent. Stated another way, the ref_num in the diff header specifies to which unique reference packet information (e.g., the index to the RST where it is stored) is modified (i.e., “diffed”) for dispatching this kernel. The diff_vector specifies the fields of this dispatch that are different from the corresponding reference packet information. Consequently, in this example, the 13 bits in the diff_vector correspond to the 13 fields in the reference AQL packet and a bit set in the diff_vector indicates that the corresponding field is different for this dispatch compared to the reference packet information. If no bit is set in the diff_vector, that means this dispatch is identical to the reference packet information. It is noted that in other implementations, the condensed packet can directly send the diff of the reference information stored in the reference table. In such cases, diff_vector specifies the fields in the reference information in the table, rather than fields in the reference AQL packet.

The format and fields of this example diff header are exemplary. It is noted that other implementations use other formats and/or fields, and/or are not specific to AQL.

For example, Table 6 illustrates an example condensed packet according to the examples above (with line numbering added for ease of reference):

TABLE 6

| | |
|---|---|
| 1. | condensed_pkt.header = |
| | HSA_PACKET_TYPE_CONDENSED_DISPATCH; |
| 2. | condensed_pkt.num_kernels = 2; //2 kernels are compressed |
| 3. | // ref_num = 4; diff only for completion signal (12^{th} bit) |
| 4. | struct diff_params param1 = {0x4, 0x1000} |
| 5. | // ref_num = 6; diff only for kernarg (11^{th} bit) |
| 6. | struct diff_params param2 = {0x6, 0x0800} |
| 7. | hsa_condensed_dispatch_packet condensed_pkt; |
| 8. | // First kernel encoding |
| 9. | condensed_pkt.diff[0] = param1; // Diff header |
| 10. | // Completion signal will take 64 bits = 4 diff[ ] entries |
| 11. | condensed_pkt.diff[1] = 0xDEAD; |
| 12. | condensed_pkt.diff[2] = 0xBEEF; |
| 13. | condensed_pkt.diff[3] = 0xFEED; |
| 14. | condensed_pkt.diff[4] = 0x0BAD; |
| 15. | // Second kernel encoding |
| 16. | condensed_pkt.diff[5] = param2; // Diff header |
| 17. | // Kern arg will take 64 bits = 4 diff[ ] entries |
| 18. | condensed_pkt.diff[6] = 0x1234; |
| 19. | condensed_pkt.diff[7] = 0x5678; |
| 20. | condensed_pkt.diff[8] = 0xDEED; |
| 21. | condensed_pkt.diff[1] = 0xFACE; |

In this example, line 1 sets the packet header to HSA_PACKET_TYPE_CONDENSED_DISPATCH, indicating that this is a condensed dispatch packet. Line 2 sets num_kernels=2 indicating that this condensed dispatch packet includes information to dispatch two kernels. Line 4 creates a diff header for the first dispatch and labels it param1. The first field of the diff header has a value=4 (0x4 in hexadecimal notation) indicating that the first dispatch is using information from reference packet #4 (e.g., stored in a reference table by index 4) for its dispatch. The second field of the diff header, that is the diff_vector, has the 12^{th} bit set, which indicates that the 12^{th} field from the reference packet #4 should be modified (i.e., “diffed”) for the first dispatch. The 12^{th} field is the completion signal field. The format and fields of this example condensed dispatch packet are exemplary. It is noted that other implementations use other formats and/or fields, and/or are not specific to AQL.

Put in other terms to illustrate the example, param1 indicates that the first dispatch is similar to reference packet #4, except in that it uses a different completion signal. Similarly, the param2 is initialized in line 6 and indicates that the second dispatch is similar to reference packet #6 except in the 11^{th} field (i.e., kernel args). Line 9 populates the first diff field (diff[0]) of the condensed packet with the diff_header of the first packet (i.e., param1). The next 4 diff fields (diff[1] to diff[4]) are populated with the completion signal for the first dispatch (lines 11-14) The completion signal is different for this dispatch than the corresponding reference packet, as indicated by the corresponding diff_header. Similarly, the diff_header corresponding to the second dispatch is populated in diff[5] (line 16) and the kernel arg address for second dispatch that is different from its reference packet is populated in diff[6] to diff[9] (lines 18-21).

FIG. 6 is a flow chart illustrating an example process 600 for kernel packet launch, execution, and cleanup using an example condensed kernel dispatch packet.

In step 602 a condensed kernel dispatch packet is enqueued for processing by a kernel agent to dispatch one or more kernels. It is assumed that information for dispatching the one or more kernels is already stored, e.g., in a RFB or other suitable memory. In some implementations, the information was previously stored in the RFB by processing a reference kernel dispatch packet for each of the one or more kernels.

In step 604, the kernel agent processes the condensed kernel dispatch packet. In some implementations, a packet processor or other packet processing circuitry of the kernel dispatch agent processes the condensed kernel dispatch packet. In other implementations, general processing circuitry of the kernel agent processes the condensed kernel dispatch packet. In some implementations, condensed kernel dispatch packet is processed to determine information for executing the one or more kernels on the kernel agent. In some implementations, the information includes dispatch information, and cleanup information. In some implementations, the information is stored in the RFB or other suitable memory location, and is indexed by a reference number (e.g., ref_num) in the condensed kernel dispatch packet for each kernel. In some implementations, the information is modified based on differential information (e.g., diff_vector) in the condensed kernel dispatch packet for one or more of the kernels.

In step 606, the kernel agent dispatches the first of the one or more kernels based on the information processed from (e.g., including diff information retrieved form the RFB) the kernel dispatch packet, and the kernel executes until completion. On condition 608 that the kernel execution completes, the next kernel, if any, is dispatched and executes until completion, based on information processed from (e.g., including diff information retrieved from the RFB based on). On condition 610 that all kernels complete, cleanup operations are performed in step 612. In some implementations, the cleanup operations are performed by the kernel agent based on the information processed from the kernel dispatch packet. On condition 614 that the application is not complete, process 600 repeats from step 602 with enqueuing of another kernel dispatch packet (or enters a different process, e.g., process 300 shown and described with respect to FIG. 3, with enqueuing of a standard kernel dispatch packet, or a reference kernel dispatch packet). Otherwise, process 600 ends.

As can be seen from the example of FIG. 6, overhead due to enqueuing and processing of the condensed kernel dispatch packet, and due to cleanup operations, accrues one time for all of the kernels launched on the kernel agent by the condensed kernel dispatch packet.

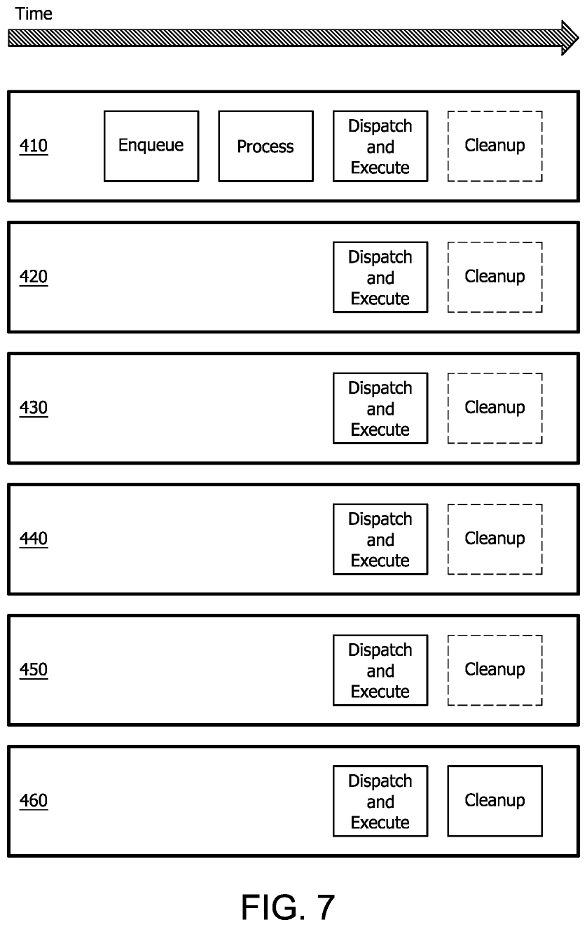

FIG. 7 is a block diagram illustrating example processing time and overhead time components associated with processing each of the kernels 410, 420, 430, 440, 450, 460 shown and described with respect to FIG. 4, according to process 600 shown and described with respect to FIG. 6.

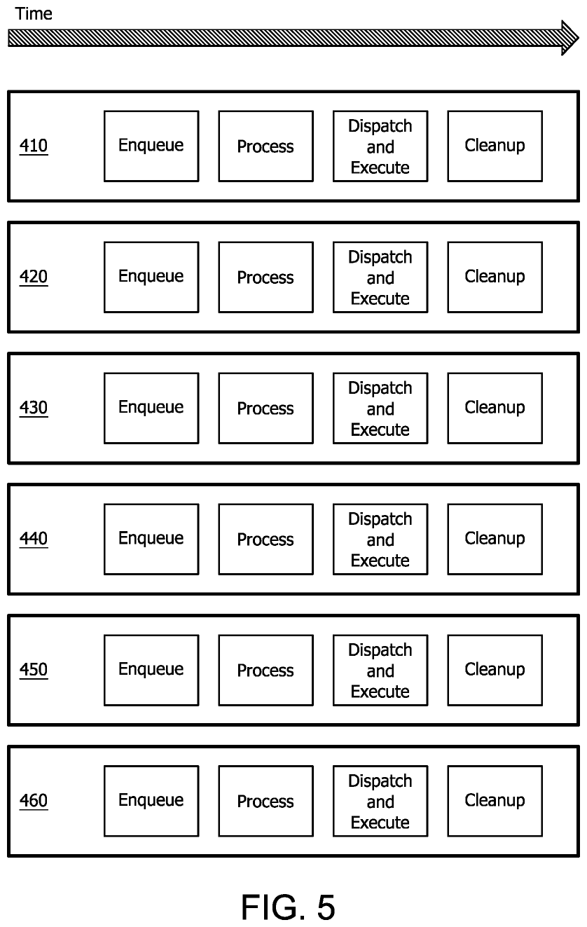

As shown, only the first kernel 410 includes a processing time due to enqueuing the kernel dispatch packet and processing the kernel dispatch packet, whereas each of the kernels 410, 420, 430, 440, 450, 460 includes a processing time for processing the kernel on the kernel agent. The final packet 460 includes processing time for cleanup operations. Packets 410, 420, 430, 440, 450 do or do not include processing time for cleanup operations depending on the cleanup information (indicated by dashed lines in the figure). Thus, the blocks shown illustrate that overall processing time for all of the kernels 410, 420, 430, 440, 450, 460 based on a condensed kernel dispatch packet is less (or at least, includes fewer elements) than overall processing time for all of the kernels 410, 420, 430, 440, 450, 460 based on a regular, or reference kernel dispatch packet (e.g., as shown and described with respect to FIG. 5. The blocks shown illustrate operations contributing to processing time for kernels 410, 420, 430, 440, 450, 460, and are not intended to be to scale, or to imply that the kernels necessarily run in parallel, although some or all kernels may in fact run in parallel or may overlap in some implementations.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the accelerated processing device 116, the scheduler 136, the graphics processing pipeline 134, the compute units 132, the SIMD units 138, may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A kernel agent configured to dispatch a compute kernel for execution, the kernel agent comprising:
circuitry configured to receive a reference kernel dispatch packet;
circuitry configured to process the reference kernel dispatch packet to determine kernel dispatch information;
circuitry configured to store the kernel dispatch information; and
circuitry configured to dispatch a kernel based on the kernel dispatch information.

2. The kernel agent of claim 1, further comprising:
circuitry configured to receive a condensed kernel dispatch packet;
circuitry configured to process the condensed kernel dispatch packet to retrieve the stored kernel dispatch information; and
circuitry configured to dispatch a kernel, based on the retrieved kernel dispatch information.

3. The kernel agent of claim 1, further comprising:
circuitry configured to receive a condensed kernel dispatch packet;
circuitry configured to process the condensed kernel dispatch packet to retrieve the kernel dispatch information and to determine difference information;
circuitry configured to modify the retrieved kernel dispatch information based on the difference information; and
circuitry configured to dispatch a kernel, based on the modified retrieved kernel dispatch information.

4. The kernel agent of claim 1, further comprising:
circuitry configured to receive a condensed kernel dispatch packet;
circuitry configured to process the condensed kernel dispatch packet to retrieve the stored kernel dispatch information and to retrieve stored second kernel dispatch information; and
circuitry configured to dispatch a kernel based on the retrieved kernel execution information, and to dispatch a second kernel based on the retrieved second kernel information.

5. The kernel agent of claim 1, further comprising:
circuitry configured to receive a condensed kernel dispatch packet;
circuitry configured to process the condensed kernel dispatch packet to retrieve the stored kernel dispatch information, to determine first difference information, to retrieve stored second kernel dispatch information, and to determine second difference information;
circuitry configured to modify the retrieved kernel dispatch information based on the first difference information;
circuitry configured to modify the retrieved second kernel dispatch information based on the second difference information; and
circuitry configured to dispatch a first kernel based on the modified kernel execution information, and to dispatch a second kernel based on the modified second kernel information.

6. The kernel agent of claim 1, further comprising a reference state buffer, wherein the kernel dispatch information is stored in the reference state buffer.

7. The kernel agent of claim 1, further comprising a scratch random access memory (RAM), wherein the kernel agent stores the kernel dispatch information in the scratch RAM.

8. The kernel agent of claim 1, wherein the kernel agent comprises a graphics processing unit (GPU).

9. The kernel agent of claim 1, further comprising circuitry configured to receive the reference kernel dispatch packet from a host processor.

10. The kernel agent of claim 1, wherein the reference kernel dispatch packet comprises architected queuing language (AQL) fields.

11. A method for launching a compute kernel, the method comprising:
receiving, by a kernel agent, a reference kernel dispatch packet;
processing, by the kernel agent, the reference kernel dispatch packet to determine kernel dispatch information;
storing, by the kernel agent, the kernel dispatch information; and
dispatching a kernel, based on the kernel dispatch information.

12. The method of claim 11, further comprising:
receiving, by the kernel agent, a condensed kernel dispatch packet;
processing, by the kernel agent, the condensed kernel dispatch packet to retrieve the stored kernel dispatch information; and
dispatching a kernel, based on the retrieved kernel dispatch information.

13. The method of claim 11, further comprising:
receiving, by the kernel agent, a condensed kernel dispatch packet;
processing, by the kernel agent, the condensed kernel dispatch packet to retrieve the kernel dispatch information and to determine difference information;
modifying the retrieved kernel dispatch information based on the difference information; and
dispatching a kernel, based on the modified retrieved kernel dispatch information.

14. The method of claim 11, further comprising:
receiving, by the kernel agent, a condensed kernel dispatch packet;
processing, by the kernel agent, the condensed kernel dispatch packet to retrieve the stored kernel dispatch information and to retrieve stored second kernel dispatch information; and
dispatching a kernel based on the retrieved kernel dispatch information, and dispatching a second kernel based on the retrieved second dispatch information.

15. The method of claim 11, further comprising:
receiving, by the kernel agent, a condensed kernel dispatch packet;
processing, by the kernel agent, the condensed kernel dispatch packet to retrieve the stored kernel dispatch information, to determine first difference information, to retrieve stored second kernel dispatch information, and to determine second difference information;
modifying the retrieved kernel dispatch information based on the first difference information;
modifying the retrieved second kernel dispatch information based on the second difference information; and
dispatching a first kernel based on the modified kernel execution information, and dispatching a second kernel based on the modified second kernel information.

16. The method of claim 11, wherein the kernel agent stores the kernel dispatch information in a reference state buffer.

17. The method of claim 11, wherein the kernel agent stores the kernel dispatch information in a scratch random access memory (RAM) on the kernel agent.

18. The method of claim 11, wherein the kernel agent comprises a graphics processing unit (GPU).

19. The method of claim 11, wherein the kernel agent receives the reference kernel dispatch packet from a host processor.

20. The method of claim 11, wherein the reference kernel dispatch packet comprises architected queuing language (AQL) fields.
